(19) United States
(12) Patent Application Publication
(10) Pub. No.: US 2020/0377004 A1
(43) Pub. Date: Dec. 3, 2020

(54) VEHICLE IMAGING AND ADVERTISING USING AN EXTERIOR GROUND PROJECTION SYSTEM

(71) Applicant: GM Global Technology Operations LLC, Detroit, MI (US)

(72) Inventors: Qinglin Zhang, Novi, MI (US); Lei Wang, Rochester Hills, MI (US); Miguel A. Saez, Clarkston, MI (US); Marcus J. Huber, Saline, MI (US); Sudhakaran Maydiga, Troy, MI (US)

(21) Appl. No.: 16/425,125

(22) Filed: May 29, 2019

(51) Int. Cl. B60Q 1/00; B60Q 1/26; G06Q 30/02

(52) U.S. Cl. CPC B60Q 1/0011; B60Q 2400/50; G06Q 30/0265; B60Q 1/2669

(57) ABSTRACT

A vehicle information system for projecting images with respect to a vehicle is provided. The vehicle information system includes an image projection device disposed on the vehicle. The image projection device is operable to project an image on a surface with respect to the vehicle. The vehicle information system also includes a vehicle-based portion that receives information regarding a status of the vehicle and determines whether the projecting images is acceptable. The vehicle-based portion also causes the image projection device to project the image on the surface with respect to the vehicle when projecting images is acceptable.

### INTRODUCTION

The subject disclosure relates to automotive lighting, and more particularly relates to methods, systems and apparatuses for displaying symbols, animations, videos and other graphics external to an automobile for advertising and marketing purposes.

Lighting systems play a number of roles in modern automobiles, such as providing needed illumination and convenience lighting at various points both internal and external to the vehicle. For example, external lighting may be used to light a ground region adjacent to doors of the vehicle to assist with ingress and egress, or to light an external door handle pocket itself. As external lighting systems become more sophisticated it may be advantageous to build brand consciousness in consumers in the form of badges, logos, graphics and other indicia relating to an automotive brand or model or to an enterprise with a relation to the automobile.

Accordingly, it is desirable to provide external lighting systems that can be used with associated branding vision systems, for providing highly targeted advertising video and images.

### SUMMARY

In accordance with one or more embodiments described herein, a vehicle information system for projecting images with respect to a vehicle is provided. The vehicle information system includes an image projection device disposed on the vehicle. The image projection device is operable to project an image on a surface with respect to the vehicle. The vehicle information system also includes a vehicle-based portion that receives information regarding a status of the vehicle and determines whether the projecting images is acceptable. The vehicle-based portion also causes the image projection device to project the image on the surface with respect to the vehicle when projecting images is acceptable.

In accordance with one or more embodiments or the vehicle information system described herein, the vehicle-based portion can be configured to transmit at least one of user preference information, vehicle information, and vehicle location information to a cloud-based portion of the vehicle information system. The vehicle-based portion can also be configured to receive, from the cloud-based portion, the image for projection by the image projection device. The image can be based on the at least one of the user preference information, the vehicle information, and the vehicle location information.

In accordance with one or more embodiments or the vehicle information system described herein, the user preference information can include a user selection regarding the images to be displayed. The vehicle information can include at least one of a vehicle type, a vehicle information system type, and an image projection device type.

In accordance with one or more embodiments or the vehicle information system described herein, the image for projection by the image projection device can include a targeted advertisement or a public safety alert.

In accordance with one or more embodiments or the vehicle information system described herein, the vehicle-based portion can include an audio visual system. The audio visual system can be configured to detect information respective to an individual in the vicinity of the vehicle and transmitting the information respective to the individual to the cloud-based portion. The audio visual system can also be configured to receive, from a cloud-based portion of the vehicle information system, the image for projection by the image projection device. The image can be based on the information respective to the individual.

In accordance with one or more embodiments or the vehicle information system described herein, the information respective to the individual can include a presence and characteristics of the individual.

In accordance with one or more embodiments or the vehicle information system described herein, the characteristics can include actions by the individual.

In accordance with one or more embodiments or the vehicle information system described herein, the vehicle-based portion can associate timing information with the image being projected.

In accordance with one or more embodiments or the vehicle information system described herein, the timing information can be transmitted by the vehicle-based portion to a cloud computing environment of the vehicle information system for employment in a monetization strategy.

In accordance with one or more embodiments or the vehicle information system described herein, the surface can be a vehicle surface or a ground surface.

In accordance with one or more embodiments, a method for projecting images with respect to a vehicle is provided. The method is implemented on a vehicle information system that is communicatively coupled to an image projection device. The image projection device is disposed on the vehicle and operable to project an image on a surface with respect to the vehicle. As part of the method, the vehicle information system has a vehicle-based portion, which receives information regarding a status of the vehicle and determines whether the projecting images is acceptable. The vehicle-based portion also causes the image projection device to project the image on the surface with respect to the vehicle when projecting images is acceptable.

In accordance with one or more embodiments or the method described herein, the method can include transmitting, by the vehicle-based portion, at least one of user preference information, vehicle information, and vehicle location information to a cloud-based portion of the vehicle information system. The method can further include receiving, by the vehicle-based portion from the cloud-based portion, the image for projection by the image projection device. The image can be based on the at least one of the user preference information, the vehicle information, and the vehicle location information.

In accordance with one or more embodiments or the method described herein, the user preference information can include a user selection regarding the images to be displayed. The vehicle information can include at least one of a vehicle type, a vehicle information system type, and an image projection device type.

In accordance with one or more embodiments or the method described herein, the image for projection by the image projection device can include a targeted advertisement or a public safety alert.

In accordance with one or more embodiments or the method described herein, the vehicle-based portion can include an audio visual system that detects information respective to an individual in the vicinity of the vehicle and transmitting the information respective to the individual to a cloud-based portion of the vehicle information system. The audio visual system can also receive from the cloud-based portion the image for projection by the image projection device. The image can be based on the information respective to the individual.

In accordance with one or more embodiments or the method described herein, the information respective to the individual can include a presence and characteristics of the individual.

In accordance with one or more embodiments or the method described herein, the characteristics can include actions by the individual.

In accordance with one or more embodiments or the method described herein, the vehicle-based portion can associate timing information with the image being projected.

In accordance with one or more embodiments or the method described herein, the timing information can be transmitted by the vehicle-based portion to a cloud computing environment of the vehicle information system for employment in a monetization strategy.

In accordance with one or more embodiments or the method described herein, the surface can include a vehicle surface or a ground surface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including a vehicle information system in accordance with an exemplary embodiment;

FIG. 2 depicts an example of a projected image generated by a projection device in accordance with an exemplary embodiment;

FIG. 3 depicts a vehicle information system with a cloud computing portion and a vehicle-based portion in accordance with an exemplary embodiment;

FIG. 4 depicts a processing system in accordance with an exemplary embodiment;

FIG. 5 depicts a vehicle information system including a cloud computing environment and a vehicle environment with interconnections and communications there between in accordance with an exemplary embodiment;

FIG. 6 depicts an example of an operation of a vehicle information system in accordance with an exemplary embodiment; and

FIG. 7 depicts an example of an operation of a vehicle information system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The following discussion generally relates to an external graphical display system for an automobile. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to lighting systems, light-emitting diodes, automotive exteriors and the like need not be described in detail herein.

In accordance with an exemplary embodiment described herein is a vehicle information system and method to use a projection device for advertising commercials or marketing purposes, as well as for the marketing paradigm of monetizing the facility of providing such advertising as a service. In an embodiment, the vehicle information system (of a vehicle) employs one or more software applications in communication with the projection device to ensure that the vehicle information system has an awareness of persons nearby, an awareness of where the vehicle is parked, and information from the vehicle, to then project highly targeted advertising videos or pictures or the like. In an embodiment, the vehicle information system communicates with a cloud computing environment to facilitate implementation and enhance functionality.

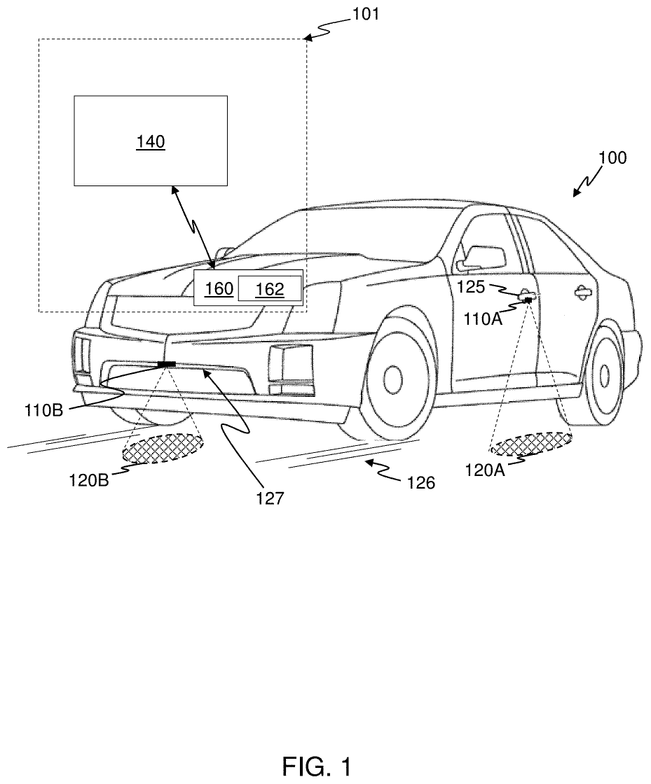

Turning to FIG. 1, a vehicle 100 (e.g., an automobile, a truck, a motorcycle and the like) with a vehicle information system 101 is depicted in accordance with one or more embodiments. The vehicle information system 101 generally includes a projection device 110. The projection device 110 is generally referred to herein in the singular for ease of explanation, while being illustrated as projection devices 110A and 110B. The projection device 110 can be coupled to vehicle 100 and configured to project an image 120 (also generally referred to herein in the singular for ease of explanation, while being illustrated as images 120A and 120B) onto a display surface.

The projection device 110 generates or projects the image 120 to a display surface that is external to the vehicle 100, internal to the vehicle 100, on the vehicle 100 or in the vicinity of the vehicle 100. For instance, the projection device 110 can have one or more LEDs, a condenser lens and a focusing lens all mounted in a housing and configured to emit light toward the display surface along an optical path so that the projection device 110 can thereby present the image 120 on the display surface. In one or more embodiments, the projection device 110 can be a laser projector.

The display surface can be a region on a body of the vehicle 100 itself (e.g., any exterior surface), any interior surface of the vehicle 100, or a region anywhere with respect to or in a vicinity of the vehicle 100. In another embodiment, the projection device 110A is located under a door handle 125 of the vehicle 100, and the display surface is a region of the ground 126 adjacent to the vehicle 100 (for example, adjacent to a side of the vehicle 100 as shown by the image 120A), thereby functioning as a “puddle light.” In another embodiment, the projection device 110B is located on a front bumper 127 of the vehicle 100, and the display surface is a region anywhere with respect to or in the vicinity of the vehicle 100 (e.g., in front of the vehicle 100 as shown by the image 120B or in the rear of the vehicle 100).

The image 120 can include any combination of images, pictures, video, graphics, alphanumerics, badging, logos, messaging, test information, other indicia relating to a brand or model or to an enterprise with a relation to the automobile, user, owner, local eateries, establishments, and the like. The image 120 can be part of information and images selected or predetermined for display, such as targeted advertisements and public safety alerts. The image 120 can include a notification to a passing pedestrian or cyclist and/or an image displayed in a front or a rear of the vehicle 100 to indicate an intended trajectory of the vehicle 100. In various embodiments, for example, the image 120 can include automotive brand indicia (e.g., “Cadillac”), model indicia (e.g., “XT5”), and/or any desired branding or badging indicia.

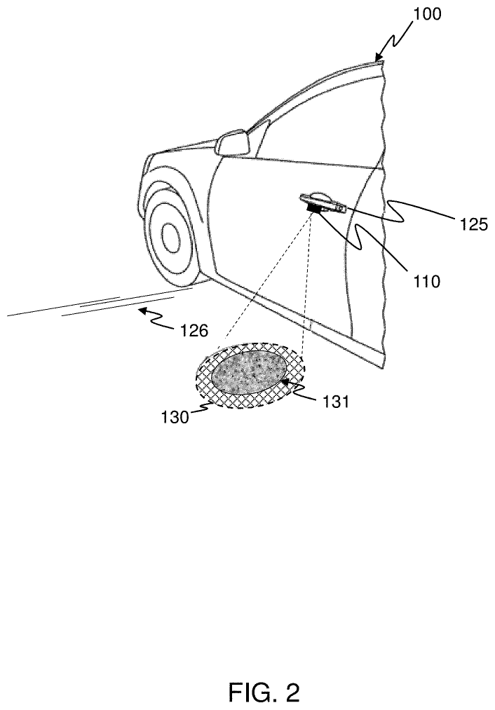

FIG. 2 depicts an example of the image 120 of FIG. 1 (e.g., an example of a projected automotive brand indicia) as generated by the projection device 110 of FIG. 1 in accordance with an exemplary embodiment. For brevity, elements of FIG. 2 that are similar to FIG. 1 are reused and not re-described. As shown in FIG. 2, a vehicle 100 includes a projection device 110 that is located under a door handle 125 of the vehicle 100, and the display surface is a region of the ground 126 adjacent to the vehicle 100 (for example, adjacent to a side of the vehicle 100 as shown by an image 130), thereby functioning as a “puddle light.” Within the image 130 is an automotive brand indicia 131 (e.g., “Cadillac”). In another embodiment, the image 130 displayed can be associated with a user, operator, contractor, and the like and the image 130 can be relating to an enterprise associated with them, (e.g., business information or logo). In other embodiments, the image 130 can include information associated with a user, client, enterprise, and the like.

Returning to FIG. 1, the vehicle information system 101 includes a cloud-based portion 150 interfaced with a vehicle-based portion 160. In accordance with one or more embodiments, operations of the vehicle information system 101 include receiving information regarding a status of the vehicle 100, determining if it is acceptable to project images 120, and enabling the projection device 110 to project a selected image on a surface (e.g., the ground 126) with respect to or in the vicinity of the vehicle 100. To support these operations, the vehicle-based portion 160 can transmit at least one of user preference information, vehicle information, and vehicle location information to the cloud-based portion 140 and can receive from the cloud-based portion 140 selected information and images to be displayed based at least in part on the at least one of user preference information, vehicle information, and vehicle location information.

The vehicle-based portion 160 can include a vehicle application 162, also referred to as a client application, operating on the vehicle 100. The vehicle application 162 can interface with the cloud-based portion 150 (e.g., cloud-based application services and/or information thereof) to provide and receive information and content (as described herein) to implement displays (e.g., the images 120) by the projection device 110. In accordance with one or more embodiments, the vehicle application 162 can be a client application of the vehicle-based portion 160, which is a local application employing local services and resources (e.g., a set of resources (data, images, files, metadata, processes, and the like) operably connected to a local on-premises computing device. In addition, the client application can include a browser-based application utilizing the cloud-based portion 150 through an application gateway or any network connected application that relies on a cloud gateway to provide access to functionality.

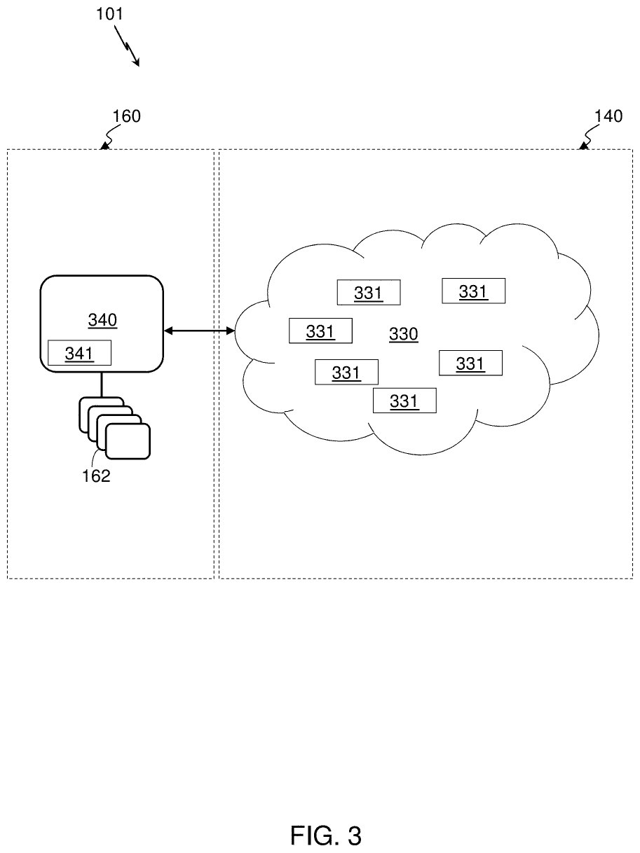

The cloud-based portion 150 can include a cloud computing environment (such as described herein with respect to a cloud computing environment 330 of FIG. 3) having various application services, resources and the like. The cloud computing environment can employ a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. An application service of the cloud-based portion 150 is a set of functions provided by a cloud application of the cloud computing environment. A cloud-based resource of the cloud-based portion 150 can be a set of cloud resources (e.g., data, images, files, metadata, processes and the like) that the cloud application (e.g., through an application service) relies upon to function.

The cloud computing environment can also include numerous operational characteristics, with several service models, as well as a variety of unique deployment models. For example, operational characteristics include, but are not limited to, on-demand self-service to provision computing capabilities, broad network access, where capabilities are available over a network and accessed through standard mechanisms (e.g., browser) that promote use by client platforms (e.g., mobile phones, laptops, wearable devices, and PDAs). Other operational characteristics can be resource pooling, where the provider's computing resources are pooled to serve multiple consumers, and rapid elasticity, where architecture capabilities can be rapidly and elastically provisioned, in some cases automatically, to quickly scale out and rapidly released to quickly scale in. Another operational characteristics can be a measured service, where cloud systems automatically control and optimize resource use by leveraging a metering capability at some level of abstraction appropriate to the type of service (e.g., storage, processing, bandwidth, and active user accounts). Note that resource usage can be monitored, controlled, and reported by the cloud computing environment thereby providing transparency for both the provider and consumer of the utilized service.

Cloud computing service models of the cloud computing environment include Software as a Service (SaaS), where the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Similarly, other service models include Platform as a Service (PaaS), and Infrastructure as a Service (IaaS).

Deployment models for cloud computing service models can be private, community, public, and hybrid cloud services. Private cloud services operate solely for an organization, can be managed by the organization or a third party and can exist on-premises or off-premises. Community cloud services are shared by several organizations and supports a specific community that has shared concerns (e.g., mission, security requirements, policy, and compliance considerations). Public cloud infrastructure is made available to the general public or a large industry group and is owned by an organization selling cloud services. Finally, with a hybrid cloud structure, the cloud infrastructure is a composition of two or more clouds (private, community, or public) that remain unique entities but are bound together by standardized or proprietary technology that enables data and application portability.

Referring now to FIG. 3, a vehicle information system 101 with a cloud-based portion 140 and a vehicle-based portion 160 is depicted. For brevity, elements of FIG. 3 that are similar to FIGS. 1-2 are reused and not re-described. As shown, the cloud-based portion 140 includes a cloud computing environment 330 as described herein. The cloud-based portion 140 includes one or more cloud computing nodes 331 with which an on-premises or on-vehicle computing device 340 can communicate. The cloud computing node 331 is generally referred to herein in the singular for ease of explanation, while being illustrated as multiple separate nodes within the cloud-based portion 140.

The cloud computing node 331 can include various communication gateways, application services and resources as needed for implementing the cloud computing environment. The cloud computing node 331 is generally connected to an on-premises local area network (LAN), wide area network (WAN), cellular network, and/or the like to facilitate communications. Examples of the cloud computing node 331 can include a personal digital assistant (PDA), cellular telephone, a desktop computer/terminal/server, a laptop computer, a vehicle, and/or a system control panel such as for a building system. Each cloud computing node 331 (also referred to as services and resources) can communicate with one another and/or be grouped (not shown) physically or virtually, in networks, such as Private, Community, Public, or Hybrid clouds as described herein, or in various combinations thereof. This allows cloud-based portion 140 to offer infrastructure, platforms and/or software as services for which a cloud consumer does not need to maintain or minimize resources at a local computing device level. In one example, the cloud-based portion 140 includes an application that communicates between any cloud computing node 331 and the on-premises or on-vehicle computing device 340 of the vehicle-based portion 160.

The on-premises or on-vehicle computing device 340 can include various sensors 341 and/or one or more vehicle applications 162 that communicate with one another as described herein. For instance, the on-premises or on-vehicle computing device 340 can employ on-vehicle computing devices to execute various vehicle applications 162 as desired (and in particular an advertising application that includes controls for the projection device 110 of FIG. 1). The on-premises or on-vehicle computing device 340 can also include one or more communications gateways to facilitate communications, local application services, in operable communication with local, client-based resources operating on the vehicle (e.g., the vehicle 100 of FIG. 1). The communication can also include the ability to establish connections as well as validate or authenticate any credential information provided to/by the cloud applications. The sensors 341 can be any transducer that converts an environmental condition (e.g., light, temperature, movement, etc.) to an electrical signal for use by the on-premises or on-vehicle computing device 340. Examples of the sensors 341 include microphones, thermometers, cameras, seat belt detectors, pressure sensors, etc. It is understood that the types of computing devices described herein are intended to be illustrative and that the cloud computing node 331 and cloud computing environment 330 can communicate with any type of computerized device over any type of network and/or network addressable connection (e.g., using a web browser).

In accordance with one or more embodiments, the one or more vehicle applications 162 and/or the cloud computing node 331 can select information and images to be displayed. The information and images can include at least one of predetermined images, targeted advertisements, and public safety alerts. Examples of the predetermined images, the targeted advertisements, and the public safety alerts includes a logo of a vehicle, a logo vehicle manufacturer (e.g., the automotive brand indicia 140 of FIG. 2), a logo of vehicle operator, an image or video selected by the user, an image or video indicative of an operation of the vehicle, an advertisement for an enterprise, a logo for the enterprise, video clips, and public safety alert messages including notices and AMBER alerts. In accordance with one or more embodiments, the information and images to be displayed can be related to fleet owner/manager and the like. For example, if the fleet owner/manager is a fleet system as part of a ride-share program, a logo of the ride-share program can be displayed by the vehicle information system 101. In accordance with one or more embodiments, when a public safety announcement is made (e.g., an AMBER alert, an evacuation warning, and the like), the cloud computing node 331 can inform the one or more vehicle applications 162 of the public safety announcement for display. Further, any displayed image can be accompanied by corresponding to safety information to anyone in the vicinity of the vehicle.

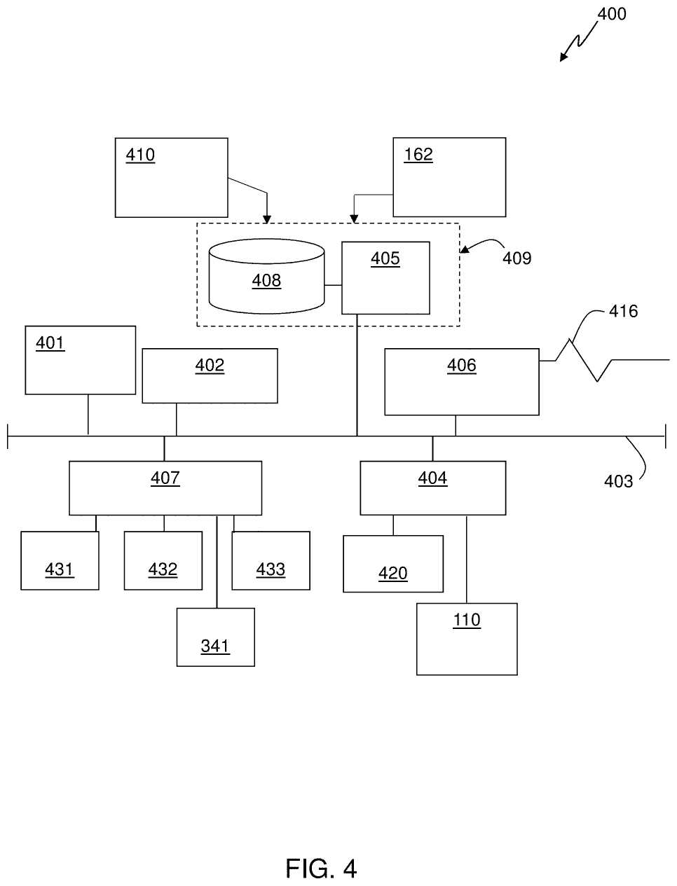

Referring to FIG. 4, there is shown an example of a processing system 400 for a given computing device (e.g., the cloud computing node 331 and the on-premises or on-vehicle computing device 340) as can be employed for implementing the teachings herein. For brevity, elements of FIG. 4 that are similar to FIGS. 1-3 are reused and not re-described. In this example, the processing system 400 has at least one central processing unit (collectively or generically referred to as a processor 401). In one example, the processor 401 can include a reduced instruction set computer (RISC) microprocessor. The processor 401 is coupled to a memory 402 and various other components via a system bus 403. The memory 402 can include a read only memory (ROM) that is also coupled to the system bus 403 and can include a basic input/output system (BIOS), which controls certain basic functions of the processing system 400. The memory 402 can also include a random access memory (RAM).

The processing system 400 includes a display adapter 404, an input/output (I/O) adapter 405, a communications adapter 406 and an interface adapter 407 coupled to the system bus 403. In one example, the adapters 404, 405, 406, and 407 can be connected to at least one I/O buss that is connected to system bus 403 via an intermediate bus bridge. Suitable I/O buses for connecting peripheral devices such as hard disk controllers, network adapters, and graphics adapters typically include common protocols, such as the Peripheral Component Interconnect (PCI).

The I/O adapter 405 can be a small computer system interface (SCSI) adapter that communicates with a hard disk 408 or any other similar component. The I/O adapter 405 and the hard disk 408 can be collectively referred to herein as a mass storage 409. An operating system 410 for execution on the processing system 400 can be stored in the mass storage 409. Likewise a vehicle application 162 (e.g., the one or more vehicle applications 162 of FIG. 3) can also be executed on the processing system 400 and stored in the mass storage 409. The communications adapter 406 interconnects bus 403 with an outside network 416 (such as cloud-based portion 140 of FIG. 1) enabling processing system 400 to communicate with other such systems. A display 420 and a projection device 110 can be connected to system bus 403 via the display adaptor 404, which can also include a graphics adapter and/or a video controller to improve the performance of graphics intensive applications. Additional input/output devices are shown as connected to system bus 403 via the user interface adapter 407. A keyboard 431, a mouse 432, a speaker 433, and a sensor 341 all interconnect to the system bus 403 via user interface adapter 407, which can include, for example, a Super I/O chip integrating multiple device adapters into a single integrated circuit.

Thus, as configured in FIG. 4, the processing system 400 includes processing capability in the form of the processor 401, storage capability including the memory 402 and the mass storage 409, input means such as the keyboard 431, the mouse 432, and the sensor 341, and output capability including the speaker 433, the display 420, and the projection device 110. In one example, a portion of the memory 402 and the mass storage 409 collectively store the operating system 410 and the vehicle application 162 to coordinate the functions of the various components shown in FIG. 4. It should be appreciated that the components of the processing system 400 as described are for illustration purposes. Features and functions as described can be omitted, integrated, or distributed as desired to suit a particular application.

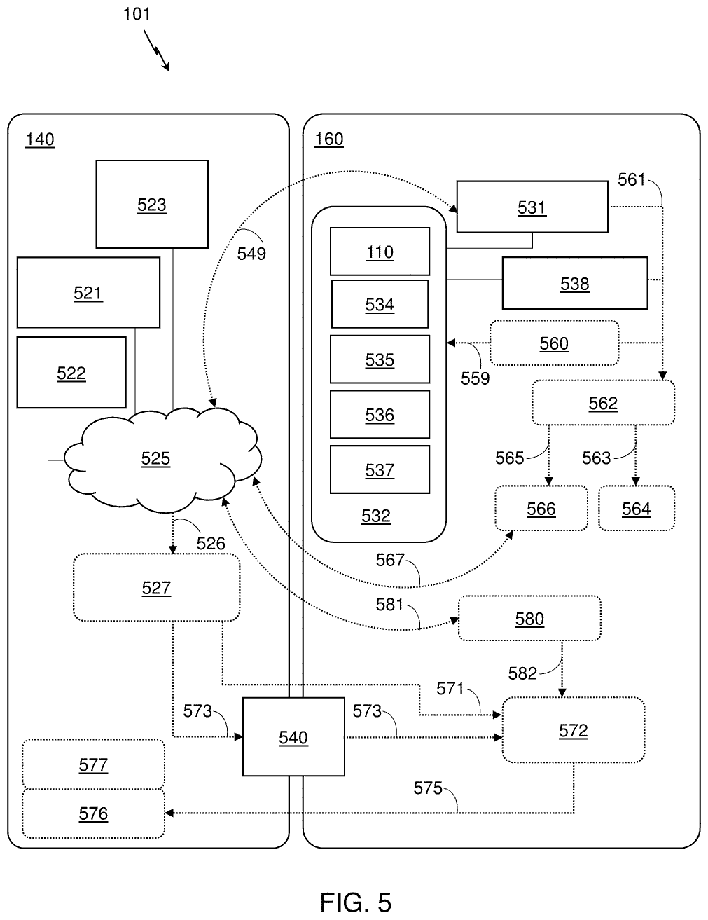

FIG. 5 depicts a vehicle information system 101 including a cloud-based portion 140 and a vehicle-based portion 160 with interconnections and communications there between in accordance with an exemplary embodiment. Further, FIG. 5 depicts operations of the vehicle information system 101 as dotted-arrows and dotted-boxes with rounded edges in accordance with an exemplary embodiment. For brevity, elements of FIG. 5 that are similar to FIGS. 1-4 are reused and not re-described. The vehicle information system 101 operates to project images, such as with respect to or in a vicinity of a vehicle (e.g., the vehicle 100 of FIG. 1). Operations of the vehicle information system 101 can include object detection with respect to the vehicle, global positioning system (GPS) operations, projection operations, user I/O, cloud storage operations, cloud processing operations, vehicle processing operations, etc.

The cloud-based portion 140 can include, but is not limited to, an application gateway 521, application services 522, and cloud-based information 523 (e.g., data), each operating on or through a cloud-based resources 525 including processing, applications, storage, and the like. The application services can include, but not be limited to, and application directed to communicating with the vehicle-based portion 160 to provide various cloud-based information 523 for display or controlling the display of information and images. For example, the cloud-based information 523 can include event information, client bidding information, advertisements, and the like. An example of the operation of the cloud-based portion 140 is to generate (e.g., arrow 526), for example, targeted advertisements 527. The targeted advertisements 527 are representative of selected information and images described herein.

The vehicle-based portion 160 can include the on-premises or on-vehicle computing device 340 as shown in FIG. 3 and/or the processing system 400 (or a portion thereof) as described with reference to FIG. 4. In this regard, the vehicle-based portion 160 can include a vehicle information and entertainment (e.g., infotainment) system supported by one or more control devices, mobile devices, servers, gateways, and the like operating as a client for the vehicle information system 101. The vehicle-based portion 160 provides a user, operator, owner, or enterprise the ability to establish communication with the cloud-based portion 140 of the vehicle information system 101, as well as invoke various cloud-based application services. The vehicle-based portion 160, through an internal vehicle application (e.g., the vehicle application 162 as shown in FIG. 1) implements a methodology that includes providing advertising and displaying images or videos via an audio/video (A/V) system 532 using user preferences 531. The user preferences 531 can be user preference information including at least a user's selections regarding images to be displayed.

The A/V system 532 is operable to provide communication for the vehicle information system 101. The A/V system 532 can support a user interface that enables direct manipulation of the user preferences 531. In operation, for example, the A/V system 532 can project images and audible information associated with a vehicle's trajectory and operation (e.g., providing a visual and audible indication that the vehicle is moving forward, backward, door opening, “Help Needed” and the like, as well as illuminating the intended path of the vehicle).

The A/V system 532 can include a projection device 110, a touch display 534, a microphone 535, a camera 536 (rear and/or front facing), and a touch panel 537. Note that the projection device 110 can be any image projection device disposed on a vehicle (e.g., the vehicle 100 of FIG. 1) and operable to project an image (e.g., the image 120 of FIG. 1) on a surface (e.g., the ground 126 of FIG. 1) with respect to or in a vicinity of the vehicle.

The vehicle-based portion 160 can include vehicle information 538. The vehicle information 538 can be gathered by the vehicle-based portion 160 from other systems, produced by sensors within the vehicle, and/or generated in response to user interactions with the vehicle. The vehicle information 538 can include a vehicle type, a vehicle information system type, an image projection device type, vehicle status, engine status information (e.g., driving, parked, engine on, engine off, moving at a speed within a range, etc.), passenger status/location (e.g., seat belt activated, seat sensor activated, seat reclined, etc.), and vehicle location.

Further, the vehicle information system 101 can include a vehicle service 540 that provides communications, in-vehicle security, emergency services, hands-free calling, turn-by-turn navigation, and remote diagnostics system. The vehicle service 540 can also be subscription-based. For example, all or a part of the vehicle information system 101 can operate as part of an existing system, such as the OnStar infrastructure and user interface.

In accordance with one or more embodiments, the vehicle-based portion 160 can synchronize (e.g., arrow 549) with the cloud computing environment 502 to establish or update the user preferences 531 within the vehicle-based portion 160. The touch display 534 can provide a user interface detailing the user preferences 531, along with selection functions (e.g., option-in/option-out features) integrated with existing features of the infotainment system of the vehicle. Further, a user or driver of the vehicle can utilize a user interface provided by the A/V system 532 to manipulate (e.g., arrow 559) the user preference 531 via user inputs 560. Any manipulation of the user preferences 531 can also be directed to various application services 522 and the like in the cloud-based portion 140 (during synchronization shown by arrow 549) and can be employed by the elements of the cloud-based portion 140 with respect to generating targeted advertisements 527.

In accordance with one or more embodiments, for example, the vehicle-based portion 160 can receive (e.g., arrow 561) various information regarding the vehicle (e.g., vehicle information 538) and user/driver (user preferences 531) to determine 562 whether it is desirable and conditions are satisfactory to permit operation of the projection device 110 for the projection of images (e.g., the image 120 of FIG. 1). The determination of whether to operate the projection device 110 and project the images can include, but not be limited to, whether the vehicle is parked, occupied, empty, locked, moving within a speed range (e.g., a speed less than 15 miles per hour), and the like. The determination of whether to operate the projection device 110 and project the images can also include weather, ground surface conditions (e.g., sunlight, wet, snow, etc.), and the like obtained from sensors of the vehicle, the cloud computing environment, or other systems in communication with the vehicle-based portion 160. If the vehicle-based portion 160 determines that no images are to be projected (e.g., conditions are not satisfactory for operating the projection device 110 and displaying images), then the vehicle-based portion 160 can proceed (e.g., arrow 563) to end operations 564. If the vehicle-based portion 160 determines that images are to be projected, then the vehicle-based portion 160 can proceed (e.g., arrow 565) to determine additional vehicle credentials, such as vehicle location 564. Once the vehicle location is determined, the vehicle location can be supplied to the cloud-based portion 140, as shown by arrow 567. For example, the vehicle-based portion 160 can transmit the location of the vehicle based on operation of a GPS system to the cloud-based resources 525 and the application services 522 to facilitate the operation of the vehicle information system 101.

In accordance with one or more embodiments, for example, the vehicle-based portion 160 can also include receiving (e.g., arrow 571) the target advertisements 527 or other information including predetermined images from the cloud-based portion 140 and enabling their projection 572 by the projection device 110. In an embodiment, one example configuration would be to employ an existing infrastructure of the vehicle service 540 to feed (e.g., arrows 573) the targeted advertisements 527 (and/or images, videos, and information) from the cloud-based portion 140 to the vehicle-based portion 160 and the projection device 110. The projection device 110 then displays the target advertisements 527 or other information. In an embodiment, counters can be utilized by the vehicle-based portion 160 to associate timing information (e.g., timestamps and/or generate timers) for the target advertisements 527 or other information being projected. The timing information can be recorded and transmitted (e.g., arrow 575) to the cloud-based portion 140. The cloud-based portion 140 can measure durations 576 employing the timing information as part of a monetization strategy 577. The monetization strategy 577 can include utilizing the (measured) durations 576 with respect to a projected image and various users/drivers and associating a fee to an owner of the image. For example, the monetization strategy 577 can include when an advertiser pays a user/operator/enterprise for displaying their advertisements.

In accordance with one or more embodiment, the vehicle-based portion 160 and/or the A/V system 532 can detect a presence and characteristics of an individual in a vicinity 580 of a vehicle (e.g., also referred to as detection information). For example, the A/V system 532 can utilize the camera 536 and the microphone 535 to ascertain if any individuals are in the vicinity of the vehicle 100. Note that the determination 562 can be made in part on the detection information (e.g., the presence and characteristics of the individual). For instance, the A/V system 532 can provide detection information to the vehicle-based portion 160, through an internal vehicle application (e.g., the vehicle application 162 as shown in FIG. 1), to facilitate the determination on whether it is acceptable to project images with the projection device 110.

In accordance with one or more embodiment, the vehicle-based portion 160 and/or the A/V system 532 can transmit (e.g., arrow 581) this detection information to the cloud-based portion 140 and receive, from the cloud-based portion 140, selected information and images to be displayed based at least in part on the detecting the detection information. For example, if individuals are detected in a vicinity of the vehicle, this information can also be directed to the cloud-based portion 140 for review and the targeted advertisements 527 can be generated/changed (e.g., arrow 526) based on the individuals detected (the advertisements, images, and the like can be targeted to the particular individual). Moreover, if based on the user preferences 531 or the vehicle information 538, images and videos can be predetermined (selected or elected) to be displayed (e.g., arrow 582) by the user/driver in the vicinity of the vehicle in accordance with vicinity detection 580.

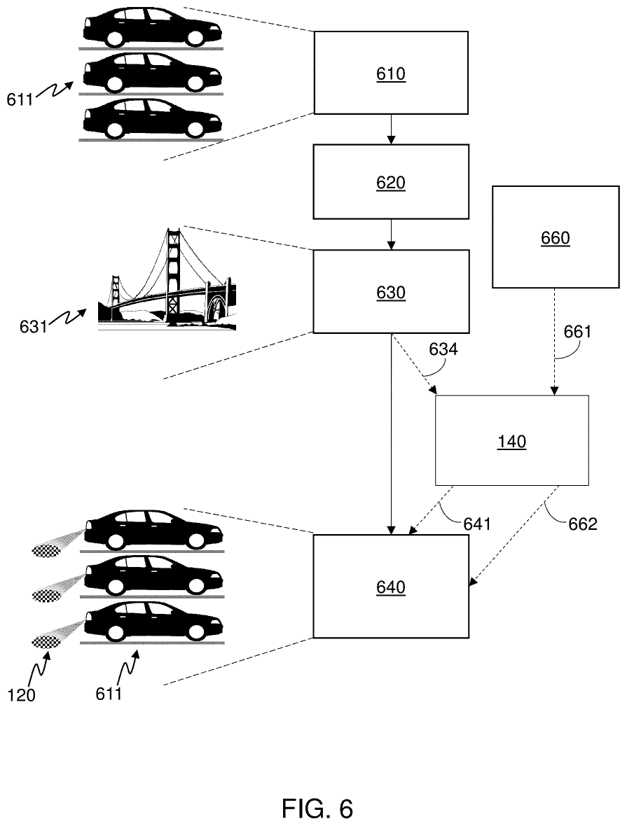

Turning now to FIG. 6, an example of an operation of a vehicle information system is depicted in accordance with an exemplary embodiment. For brevity, elements of FIG. 6 that are similar to FIGS. 1-5 are reused and not re-described. At block 610, each vehicle information system (e.g., the vehicle information system 101 of FIG. 5) resident in each vehicle of a set of vehicles 611 identifies from vehicle information (e.g., the vehicle information 538 of FIG. 5) that its corresponding vehicle is parked and charging. At block 620, the vehicle information system determines (e.g., determination 562 of FIG. 5) that it would be ok to project images. At block 630, a location is determined as being in an urban area (e.g., San Francisco 631). The location can be determined by GPS. The location is provided (e.g., arrow 634) to the cloud-based portion 140, which identifies targeted advertisements (e.g., the target advertisements 527 of FIG. 5). At block 640, the set of vehicles 611 enables their respective projection systems (e.g., the projection device 110 of FIG. 1 disposed on each vehicle 100). That is, the cloud-based portion 140 provides (e.g., arrow 641) the targeted advertisements to the set of vehicles 611 and each vehicle provides an image 120 on a surface with respect to the targeted advertisements (e.g., a make and model of each vehicle is displayed). As shown in block 660, it can be the case that a public safety message is generated. This public safety message can be provided (e.g., arrow 661) to the cloud-based portion 140, and the cloud-based portion 140 can provide (e.g., arrow 662) the public safety message to the set of vehicles 611. The set of vehicles 611, in turn, provides as the image 120 the public safety message.

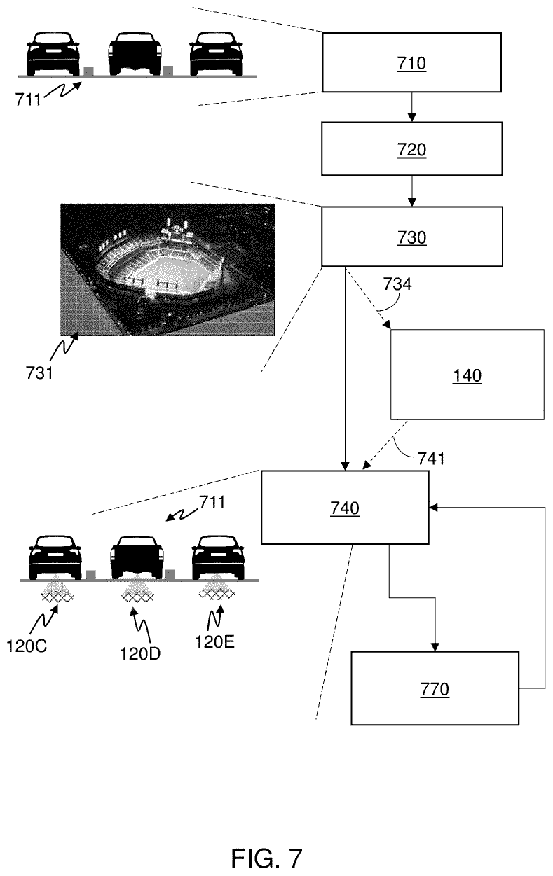

Turning now to FIG. 7, an example of an operation of a vehicle information system 101 is depicted in accordance with an exemplary embodiment. As shown at block 710, each vehicle information system (e.g., the vehicle information system 101 of FIG. 5) resident in each vehicle of a set of vehicles 711 identifies from vehicle information (e.g., the vehicle information 538 of FIG. 5) that its corresponding vehicle is parked. At block 620, the vehicle information system determines (e.g., determination 562 of FIG. 5) that it would be ok to project images. At block 630, a location is determined as being in a parking area 731 of a stadium. The location can be determined by GPS. The location is provided (e.g., arrow 734) to the cloud-based portion 140, which identifies targeted advertisements (e.g., the target advertisements 527 of FIG. 5).

At block 740, the set of vehicles 711 enables their respective projection systems (e.g., the projection device 110 of FIG. 1 disposed on each vehicle 100). That is, the cloud-based portion 140 provides (e.g., arrow 741) the targeted advertisements to the set of vehicles 711 and each vehicle provides an image 120 on a surface with respect to the targeted advertisements. For example, a first vehicle provides an image 120C of an advertisement for food, a second vehicle provides an image 120D of a logo for a restaurant (not shown), and a third vehicle provides an image 120E of a logo for the Detroit Tigers. As shown in block 770, each vehicle information system resident in each vehicle of the set of vehicles 711 can monitor a user's actions via cameras/microphones and detect user feedback. In this regard, a presence and characteristics of an individual in a vicinity of the set of the vehicles 711 can be detected (e.g., the vicinity detection 580 of FIG. 5). The characteristics can include actions by the user, such as if a user makes a gesture directed to the image 120D and/or verbalizes that the user desires to go to the closest McDonald restaurant to the parking area 731. In this way, the vehicle information system resident in the vehicle can infer the user intent (as a selection or the like) and alter the image 120D to provide directions and/or a menu. In another examples, the user action can be a swipe gesture that is interpreted as a user's desire to change the image 120D and see different information.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A vehicle information system for projecting images with respect to a vehicle, the vehicle information system comprising:
an image projection device disposed on the vehicle, the image projection device operable to project an image on a surface with respect to the vehicle;
a vehicle-based portion configured to:
receive information regarding a status of the vehicle;
determine whether the projecting images is acceptable; and
cause the image projection device to project the image on the surface with respect to the vehicle when projecting images is acceptable.

2. The vehicle information system for projecting images of claim 1, wherein the vehicle-based portion is configured to:
transmit at least one of user preference information, vehicle information, and vehicle location information to a cloud-based portion of the vehicle information system; and
receive, from the cloud-based portion, the image for projection by the image projection device, the image being based on the at least one of the user preference information, the vehicle information, and the vehicle location information.

3. The vehicle information system for projecting images of claim 2, wherein the user preference information comprises a user selection regarding the images to be displayed, and
wherein the vehicle information comprises at least one of a vehicle type, a vehicle information system type, and an image projection device type.

4. The vehicle information system for projecting images of claim 1, wherein the image for projection by the image projection device comprises a targeted advertisement or a public safety alert.

5. The vehicle information system for projecting images of claim 1, wherein the vehicle-based portion comprises an audio visual system configured to:
detect information respective to an individual in a vicinity of the vehicle and transmitting the information respective to the individual to the cloud-based portion, and
receive, from a cloud-based portion of the vehicle information system, the image for projection by the image projection device, the image being based on the information respective to the individual.

6. The vehicle information system for projecting images of claim 5, wherein the information respective to the individual comprises a presence and characteristics of the individual.

7. The vehicle information system for projecting images of claim 6, wherein the characteristics comprise actions by the individual.

8. The vehicle information system for projecting images of claim 1, wherein the vehicle-based portion associates timing information with the image being projected.

9. The vehicle information system for projecting images of claim 8, wherein the timing information is transmitted by the vehicle-based portion to a cloud computing environment of the vehicle information system for employment in a monetization strategy.

10. The vehicle information system for projecting images of claim 1, wherein the surface comprises a vehicle surface or a ground surface.

11. A method for projecting images with respect to a vehicle, the method being implemented on a vehicle information system communicatively coupled to an image projection device that is disposed on the vehicle, the image projection device being operable to project an image on a surface with respect to the vehicle, the vehicle information system having a vehicle-based portion, the method comprising:
receiving, by the vehicle-based portion, information regarding a status of the vehicle;
determining, by the vehicle-based portion, whether the projecting images is acceptable; and
causing, by the vehicle-based portion, the image projection device to project the image on the surface with respect to the vehicle when projecting images is acceptable.

12. The method for projecting images of claim 11, wherein the method further comprises:
transmitting, by the vehicle-based portion, at least one of user preference information, vehicle information, and vehicle location information to a cloud-based portion of the vehicle information system; and
receiving, by the vehicle-based portion from the cloud-based portion, the image for projection by the image projection device, the image being based on the at least one of the user preference information, the vehicle information, and the vehicle location information.

13. The method for projecting images of claim 12, wherein the user preference information comprises a user selection regarding the images to be displayed, and
wherein the vehicle information comprises at least one of a vehicle type, a vehicle information system type, and an image projection device type.

14. The method for projecting images of claim 11, wherein the image for projection by the image projection device comprises a targeted advertisement or a public safety alert.

15. The method for projecting images of claim 11, wherein the vehicle-based portion comprises an audio visual system, and
wherein the method further comprises:
detecting, by the audio visual system, information respective to an individual in a vicinity of the vehicle and transmitting the information respective to the individual to a cloud-based portion of the vehicle information system, and
receiving by the audio visual system from the cloud-based portion, the image for projection by the image projection device, the image being based on the information respective to the individual.

16. The method for projecting images of claim 15, wherein the information respective to the individual comprises a presence and characteristics of the individual.

17. The method for projecting images of claim 16, wherein the characteristics comprise actions by the individual.

18. The method for projecting images of claim 11, wherein the vehicle-based portion associates timing information with the image being projected.

19. The method for projecting images of claim 18, wherein the timing information is transmitted by the vehicle-based portion to a cloud computing environment of the vehicle information system for employment in a monetization strategy.

20. The method for projecting images of claim 11, wherein the surface comprises a vehicle surface or a ground surface.
